(19) United States
(12) Patent Application Publication
(10) Pub. No.: US 2021/0349192 A1
(43) Pub. Date: Nov. 11, 2021

(54) HYBRID DETECTORS FOR VARIOUS DETECTION RANGE IN LIDAR

(71) Applicant: Beijing Voyager Technology Co., Ltd., Beijing (CN)

(72) Inventors: Youmin Wang, Mountain View, CA (US); Yonghong Guo, Mountain View, CA (US); Anan Pan, Fremont, CA (US); Yue Lu, Mountain View, CA (US); Lingkai Kong, Palo Alto, CA (US)

(21) Appl. No.: 16/869,403

(22) Filed: May 7, 2020

(51) Int. Cl. G01S 7/4863; G01S 7/481; G01S 17/931

(52) U.S. Cl. CPC G01S 7/4863; G01S 17/931; G01S 7/4816

(57) ABSTRACT

A light detection and ranging system includes a receiver that includes a first photodetector configured to detect individual photons, a second photodetector characterized by a linear response to an intensity level of incident light, and a receiver optic device. The receiver optic device collects returned light from a first field of view and a second field of view of the receiver, directs the returned light from the first field of view of the receiver to the first photodetector, and directs the returned light from the second field of view of the receiver to the second photodetector.

### CROSS-REFERENCES TO RELATED APPLICATIONS

The following two U.S. patent applications listed below (which include the present application) are being filed concurrently, and the entire disclosure of the other application is hereby incorporated by reference into this application for all purposes:
application Ser. No. ______, filed ______, and entitled “Hybrid Detectors For Various Detection Range In LiDAR” (Attorney Docket No. 103343-1178006-003400US);
application Ser. No. ______, filed ______, and entitled “Enhanced Polarized Light Collection In Coaxial LiDAR Architecture” (Attorney Docket No. 103343-1178007-003401US).

### BACKGROUND

Modern vehicles are often equipped with sensors designed to detect objects and landscape features around the vehicle in real-time to enable technologies such as lane change assistance, collision avoidance, and autonomous driving. Some commonly used sensors include image sensors (e.g., infrared or visible light cameras), acoustic sensors (e.g., ultrasonic parking sensors), radio detection and ranging (RADAR) sensors, magnetometers (e.g., passive sensing of large ferrous objects, such as trucks, cars, or rail cars), and light detection and ranging (LiDAR) sensors.

A LiDAR system typically uses a light source and a light detection system to estimate distances to environmental features (e.g., pedestrians, vehicles, structures, plants, etc.). For example, a LiDAR system may transmit a light beam (e.g., a pulsed laser beam) to illuminate a target and measure the time it takes for the transmitted light beam to arrive at the target and then return to a receiver (e.g., a photodetector) near the transmitter or at a known location. In some LiDAR systems, the light beam emitted by the light source may be steered across a region of interest according to a scanning pattern to generate a “point cloud” that includes a collection of data points corresponding to target points in the region of interest. The data points in the point cloud may be dynamically and continuously updated, and may be used to estimate, for example, a distance, dimension, and location of an object relative to the LiDAR system.

LiDAR systems used in, for example, autonomous driving or driving assistance, often need to have both a high accuracy and a high sensitivity over a large range and field of view, for safety, user experience, and other reasons. For example, LiDAR systems that have both a high probability of detection and a low probability of false alarm are generally needed in vehicles, such as automobiles and aerial vehicles.

### SUMMARY

Techniques disclosed herein relate generally to light detection and ranging (LiDAR) systems. More specifically, and without limitation, disclosed herein are techniques for improving the detection performance of LiDAR systems by using hybrid detectors in the receivers of the LiDAR systems to achieve both a high accuracy and a high sensitivity for object detection in a wide distance range. Various inventive embodiments are described herein, including devices, units, subsystems, modules, systems, methods, and the like.

According to certain embodiments, a LiDAR system may include a receiver that may include a first photodetector configured to detect individual photons, a second photodetector characterized by a linear response to an intensity level of incident light, and a receiver optic device. The receiver optic device may be configure to collect returned light from a first field of view and a second field of view of the receiver, direct the returned light from the first field of view of the receiver to the first photodetector, and direct the returned light from the second field of view of the receiver to the second photodetector.

In some embodiments of the LiDAR system, the first photodetector may include at least one of a single-photon avalanche photodiode, a silicon photomultiplier, a multi-pixel photon counter, or a photomultiplier tube. In some embodiments, the first photodetector may be characterized by a gain greater than 1000. In some embodiments, the first photodetector may be configured to count a total number of received photons. In some embodiments, the first photodetector may include a photodiode that is reverse-biased at a bias voltage greater than a breakdown voltage of the photodiode such that an avalanche process is triggered when the first photodetector absorbs a photon. In some embodiments, the receiver may further include a quenching circuit configured to reduce the bias voltage of the first photodetector after the avalanche process is triggered. In some embodiments, the quenching circuit may include a passive quenching circuit or an active quenching circuit. In some embodiments, the first field of view may include a field that is at least 200 meters from the receiver.

In some embodiments of the LiDAR system, the second photodetector may be characterized by a gain greater than 10. The gain of the second photodetector may be a linear function of a reverse bias voltage applied to the second photodetector. In some embodiments, the second photodetector may include an avalanche photodiode. In some embodiments, the receiver optic device may include a lens, a lens assembly, a surface-relief grating, or a volume Bragg grating. The returned light may be characterized by a wavelength between 0.80 and 1.55 μm.

In some embodiments of the LiDAR system, the receiver may further include a third photodetector, and the receiver optic device may further be configured to direct returned light from a third field of view of the receiver to the third photodetector. In some embodiments, the LiDAR system may include a light source configured to emit infrared light, and a scanner configured to direct the infrared light emitted by the light source to the first field of view and the second field of view of the receiver.

According to certain embodiments, a LiDAR receiver may include a first photodetector characterized by a first gain greater than 1000, a second photodetector characterized by a second gain less than 1000 and a linear response to an intensity level of incident light, and a receiver optic device. The receiver optic device may be configure to collect returned light from a first field of view and a second field of view of the LiDAR receiver, direct the returned light from the first field of view of the LiDAR receiver to the first photodetector, and direct the returned light from the second field of view of the LiDAR receiver to the second photodetector.

In some embodiments of the LiDAR receiver, the first photodetector may include at least one of a single-photon avalanche photodiode, a silicon photomultiplier, a multi-pixel photon counter, or a photomultiplier tube. The second photodetector may include an avalanche photodiode. The first field of view may include a field that is at least 200 meters from the LiDAR receiver. In some embodiments, the receiver optic device may include at least one of a lens, a lens assembly, a surface-relief grating, or a volume Bragg grating.

The terms and expressions that have been employed are used as terms of description and not of limitation, and there is no intention in the use of such terms and expressions of excluding any equivalents of the features shown and described or portions thereof. It is recognized, however, that various modifications are possible within the scope of the systems and methods claimed. Thus, it should be understood that, although the present system and methods have been specifically disclosed by examples and optional features, modification and variation of the concepts herein disclosed should be recognized by those skilled in the art, and that such modifications and variations are considered to be within the scope of the systems and methods as defined by the appended claims.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

### BRIEF DESCRIPTION OF THE DRAWINGS

Aspects and features of the various embodiments will be more apparent by describing examples with reference to the accompanying drawings, in which like reference numerals refer to like components or parts throughout the drawings.

FIG. 1 illustrates an example of a vehicle including a light detection and ranging (LiDAR) system according to certain embodiments.

FIG. 2 is a simplified block diagram of an example of a LiDAR system according to certain embodiments.

FIGS. 3A and 3B illustrate an example of a LiDAR system according to certain embodiments. FIG. 3A illustrates an example of a beam steering operation by the LiDAR system according to certain embodiments. FIG. 3B illustrates an example of a returned beam detection operation by the LiDAR system according to certain embodiments.

FIG. 4 is a simplified diagram of an example of an optical subsystem in a LiDAR system according to certain embodiments.

FIG. 5A illustrates an example of a LiDAR system for detecting objects in different distance ranges. FIG. 5B illustrates an example of a relation between the received signal strength and the object distance for an example of a LiDAR system.

FIG. 6A illustrates an example of a LiDAR system having multiple photodetectors for different detection ranges according to certain embodiments. FIG. 6B illustrates an example of a surface-relief grating that can be used in receiver optics to separate returned light from different ranges according to certain embodiments. FIG. 6C illustrates an example of a volume Bragg grating that can be used in receiver optics to separate returned light from different ranges according to certain embodiments.

FIG. 7 illustrates the operation conditions and current-voltage (I-V) curves for different types of photodetectors.

FIG. 8A illustrates an example of a PIN photodetector. FIG. 8B illustrates an example of an operation condition of the PIN photodetector shown in FIG. 8A.

FIG. 9A illustrates an example of an avalanche photodiode (APD) for light detection. FIG. 9B illustrates an example of an operation condition of the APD shown in FIG. 9A. FIG. 9C illustrates examples of I-V curves of the APD shown in FIG. 9A illuminated by light of different intensities.

FIG. 10A illustrates an example of a single-photon avalanche photodiode (SPAD) for light detection. FIG. 10B illustrates an example of an operation condition of the SPAD shown in FIG. 10A.

FIG. 11A shows an example of an I-V curve and operating states of a SPAD. FIG. 11B is a simplified circuit for light detection using a SPAD according to certain embodiments.

FIG. 12 is a simplified block diagram of an example of a computer system for implementing some techniques disclosed herein according to certain embodiments.

### DETAILED DESCRIPTION

Techniques disclosed herein relate generally to light detection and ranging (LiDAR) systems, and more specifically, to techniques for improving the detection performance of LiDAR systems by using hybrid detectors in the receivers of the LiDAR systems to achieve both a high accuracy and a high sensitivity for object detection in a wide distance range. Various inventive embodiments are described herein, including devices, systems, circuits, methods, non-transitory computer-readable storage media storing programs, code, or instructions executable by one or more processors, and the like.

A LiDAR system may use a transmitter subsystem that transmits pulsed light beams (e.g., infrared light beam), and a receiver subsystem that receives the returned pulsed light beam and detects objects (e.g., people, animals, and automobiles) and environmental features (e.g., trees and building structures). A LiDAR system carried by a vehicle (e.g., an automobile or an unmanned aerial vehicle) may be used to determine the vehicle's relative position, speed, and direction with respect to other objects or environmental features, and thus may, in some cases, be used for autonomous driving, auto-piloting, driving assistance, parking assistance, collision avoidance, and the like. It may be desirable for a LiDAR system to maintain both a high accuracy (e.g., a low probability of false alarm) and a high sensitivity (e.g., a high probability of detection) for a wide detection range (e.g., from about 1 meter to about 200 or 300 meters). However, it may often be difficult for a LiDAR to achieve both a large dynamic range and a long distance detection range.

For example, most 905 nm LiDAR systems may use avalanche photodiodes (APDs) that may have a relatively low gain and thus may not be suitable for light detection in long ranges, where the intensity of the returned light may be very low. Single-photon avalanche photodiodes (SPADs), such as a silicon photomultiplier (SiPM) that includes an array of SPADs, may have single photon detection capability, and thus may detect light with very low intensity and improve the detection range of the LiDAR system. SPADs may function as optical switches that may only have an “ON” state and an “OFF” state. SiPMs that include arrays of SPADs may be used to count individual photons. However, a SPAD may trigger detection signal saturation each time the SPAD detects at least one photo. Thus, the dynamic range of the SPADs and SiPMs may be low, and may not be suitable for near range detection or detection of many different light intensity levels.

According to certain embodiments disclosed herein, a LiDAR system may include a receiver that includes an APD for near range detection and an SiPM for long range detection. The APD is capable of detecting light intensity in a linear mode, and therefore can generate detection signals with high dynamic ranges for short and middle range detection. The high dynamic range of the detection signal can be utilized by increasing the number of bits (and the resolution) of the analog-to-digital converter following the detector and a low noise amplifier. The SiPM can have a very high gain value, and therefore can be used to detect weaker light signal returned from long distances to improve the long range detection capability of the LiDAR system. Because the intensity level of the long range signal is low, LiDAR systems with low dynamic ranges can be used if there are no high intensity interference signals from the shorter ranges, and thus the LiDAR systems can use SiPMs for long range detection.

In the following description, for the purposes of explanation, specific details are set forth in order to provide a thorough understanding of examples of the disclosure. It will be apparent that various examples may be practiced without these specific details. The ensuing description provides examples only, and is not intended to limit the scope, applicability, or configuration of the disclosure. Rather, the ensuing description of the examples will provide those skilled in the art with an enabling description for implementing an example. It should be understood that various changes may be made in the function and arrangement of elements without departing from the spirit and scope of the disclosure as set forth in the appended claims. The figures and description are not intended to be restrictive. Circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples. The teachings disclosed herein can also be applied to various types of applications such as mobile applications, non-mobile application, desktop applications, web applications, enterprise applications, and the like. Further, the teachings of this disclosure are not restricted to a particular operating environment (e.g., operating systems, devices, platforms, and the like) but instead can be applied to multiple different operating environments.

Furthermore, examples may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

Where components are described as being “configured to” perform certain operations, such configuration may be accomplished, for example, by designing electronic circuits or other hardware to perform the operation, by programming or controlling electronic circuits (e.g., microprocessors, or other suitable electronic circuits) to perform the operation, or any combination thereof.

The word “example” or “exemplary” is used herein to mean “serving as an example, instance, or illustration.” Any embodiment or design described herein as “exemplary” or “example” is not necessarily to be construed as preferred or advantageous over other embodiments or designs.

A LiDAR system is an active remote sensing system that can be used to obtain the range from a transmitter to one or more points on a target in a field of view (FOV). A LiDAR system uses a light beam, typically a laser beam, to illuminate the one or more points on the target. Compared with other light sources, a laser beam may propagate over long distances without spreading significantly (highly collimated), and can be focused to small spots so as to deliver high optical power densities and provide fine resolution. The laser beam may be modulated such that the transmitted laser beam may include a series of pulses. The transmitted laser beam may be directed to a point on the target, which may then reflect or scatter the transmitted laser beam. The laser beam reflected or scattered from the point on the target back to the LiDAR system can be measured, and the time of flight (ToF) from the time a pulse of the transmitted light beam is transmitted from the transmitter to the time the pulse arrives at a receiver near the transmitter or at a known location may be measured. The range from the transmitter to the point on the target may then be determined by, for example, r=c×t/2, where r is the range from the transmitter to the point on the target, c is the speed of light in free space, and t is the ToF of the pulse of the light beam from the transmitter to the receiver.

A LiDAR system may include, for example, a single-point scanning system or a single-pulse flash system. A single-point scanning system may use a scanner to direct a pulsed light beam (e.g., a pulsed laser beam) to a single point in the field of view at a time and measure the reflected or backscattered light beam with a photodetector. The scanner may then slightly tilt the pulsed light beam to illuminate the next point, and the process may be repeated to scan the full field of view. A flash LiDAR system, on the other hand, may transmit a wider-spread light beam and use a photodiode array (e.g., a focal-plane array (FPA)) to measure the reflected or backscattered light at several points simultaneously. Due to the wider beam spread, a flash LiDAR system may scan a field of view faster than a single-point scanning system, but may need a much more powerful light source to simultaneously illuminate a larger area.

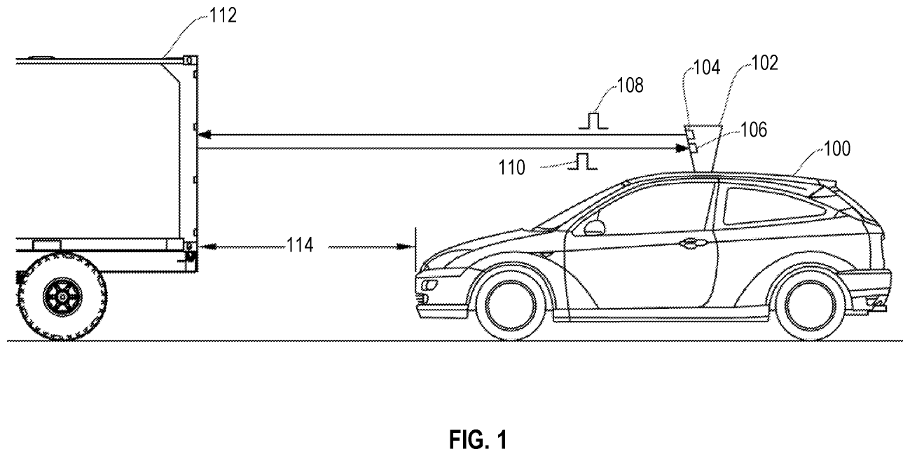

FIG. 1 illustrates an example of a vehicle 100 including a LiDAR-based detection system according to certain embodiments. Vehicle 100 may include a LiDAR system 102. LiDAR system 102 may allow vehicle 100 to perform object detection and ranging in the surrounding environment. Based on the result of the object detection and ranging, vehicle 100 may, for example, automatically maneuver (with little or no human intervention) to avoid a collision with an object in the environment. LiDAR system 102 may include a transmitter 104 and a receiver 106. In some embodiments, transmitter 104 and receiver 106 may share at least some optical components. For example, in a coaxial LiDAR system, the outgoing light from transmitter 104 and returned light to receiver 106 may be directed by a same scanning system and may at least partially overlap in space.

Transmitter 104 may direct one or more light pulses 108 (or a frequency modulated continuous wave (FMCW) light signal, an amplitude modulated continuous wave (AMCW) light signal, etc.), at various directions at different times according to a suitable scanning pattern. Receiver 106 may detect returned light pulses 110, which may be portions of transmitted light pulses 108 that are reflected or scattered by one or more areas on one or more objects. LiDAR system 102 may detect the object based on the detected light pulses 110, and may also determine a range (e.g., a distance) of each area on the detected objects based on a time difference between the transmission of a light pulse 108 and the reception of a corresponding light pulse 110, which is referred to as the time of flight. Each area on a detected object may be represented by a data point that is associated with a 2-D or 3-D direction and distance with respect to LiDAR system 102.

The above-described operations can be repeated rapidly for many different directions. For example, the light pulses can be scanned using various scanning mechanisms (e.g., spinning mirrors or MEMS devices) according to a one-dimensional or two-dimensional scan pattern for two-dimensional or three-dimensional detection and ranging. The collection of the data points in the 2-D or 3-D space may form a “point cloud,” which may indicate, for example, the direction, distance, shape, and dimensions of a detected object relative to the LiDAR system.

In the example shown in FIG. 1, LiDAR system 102 may transmit light pulse 108 towards a field in front of vehicle 100 at time T1, and may receive, at time T2, a returned light pulse 110 that is reflected by an object 112 (e.g., another vehicle). Based on the detection of light pulse 110, LiDAR system 102 may determine that object 112 is in front of vehicle 100. In addition, based on the time difference between T1 and T2, LiDAR system 102 may determine a distance 114 between vehicle 100 and object 112. LiDAR system 102 may also determine other useful information, such as a relative speed and/or acceleration between two vehicles and/or the dimensions of the detected object (e.g., the width or height of the object), based on additional light pulses detected. As such, vehicle 100 may be able to adjust its speed (e.g., slowing down, accelerating, or stopping) to avoid collision with other objects, or may be able to control other systems (e.g., adaptive cruise control, emergency brake assist, anti-lock braking systems, or the like) based on the detection and ranging of objects by LiDAR system 102.

LiDAR systems may detect objects at distances ranging from a few meters to more than 200 meters. Because of its ability to collimate laser light and its short wavelength (e.g., about 905 nm to about 1,550 nm), LiDAR using infrared (IR) light may achieve a better spatial or angular resolution (e.g., on the order of 0.10) for both azimuth and elevation than radars, thereby enabling better object classification. This may allow for high-resolution 3D characterization of objects in a scene without significant backend processing. In contrast, radars using longer wavelengths, for example, about 4 mm for about 77 GHz signals, may not be able to resolve small features, especially as the distance increases. LiDAR systems may also have large horizontal (azimuth) FOVs, and better vertical (elevation) FOVs than radars. LiDAR systems can have very high performance at night. LiDAR systems using modulated LiDAR techniques may be robust against interference from other sensors.

The strength or signal level of the returned light pulses may be affected by many factors, including, but not limited to, the transmitted light signal strength, the light incident angle on an object, the object reflection or scattering characteristics, the attenuation by the propagation medium, the system front end gain or loss, the loss caused by optical components in LiDAR system 102, and the like. The noise floor may be affected by, for example, the ambient light level and front end gain settings. Generally, in a LiDAR system, the signal-to-noise ratio (SNR) of the measured signal for middle and long ranges may decrease with the increase in the distance of detection. For objects in a certain short or middle range (e.g., about 20 m), the signal levels of the returned light pulses may be much higher compared with the ambient noise level, and thus the SNR of the detection signal of the photodetector can be relatively high. On the other hand, light pulse signals returned from long ranges (e.g., about 200 m) may be significantly weaker and may have signal strength levels similar to the ambient noise level and thus a low SNR, or may not even be detected by some low sensitivity photodetectors. In addition, some LiDAR systems may have difficulty detecting objects at close distances because the time of flight is short and the LiDAR optics may be configured for middle to long range detection. For example, without a more complex assembly, one set of lenses may not be good for both short distances (e.g., <1 m) and long distances (e.g., >40 m).

Thus, even though not shown in FIG. 1, in some embodiments, vehicle 100 may include other sensors at various locations, such as, for example, cameras, ultrasonic sensors, radar sensors (e.g., short- and long-range radars), a motion sensor or an inertial measurement unit (IMU, e.g., an accelerometer and/or a gyroscope), a wheel sensor (e.g., a steering angle sensor or rotation sensor), a GNSS receiver (e.g., a GPS receiver), and the like. Each of these sensors may generate signals that provide information relating to vehicle 100 and/or the surrounding environment. Each of the sensors may send and/or receive signals (e.g., signals broadcast into the surrounding environment and signals returned from the ambient environment) that can be processed to determine attributes of features (e.g., objects) in the surrounding environment. LiDARs, radars, ultrasonic sensors, and cameras each have their own advantages and disadvantages. Highly or fully autonomous vehicles typically use multiple sensors to create an accurate long-range and short-range map of a vehicle's surrounding environment, for example, using sensor fusion techniques. In addition, it is also desirable to have sufficient overlap of coverage by the different sensors in order to increase redundancy and improve safety and reliability.

The cameras may be used to provide visual information relating to vehicle 100 and/or its surroundings, for example, for parking assistance, traffic sign recognition, pedestrian detection, lane markings detection and lane departure warning, surround view, and the like. The cameras may include a wide-angle lens, such as a fisheye lens that can provide a large (e.g., larger than 150°) angle of view. Multiple cameras may provide multiple views that can be stitched together to form an aggregated view. For example, images from cameras located at each side of vehicle 100 can be stitched together to form a 360° view of the vehicle and/or its surrounding environment. Cameras are cost-efficient, easily available, and can provide color information. However, cameras may depend strongly on the ambient light conditions, and significant processing may need to be performed on the captured images to extract useful information.

In some embodiments, vehicle 100 may include ultrasonic sensors on the front bumper, the driver side, the passenger side, and/or the rear bumper of vehicle 100. The ultrasonic sensors may emit ultrasonic waves that can be used by the vehicle control system to detect objects (e.g., people, structures, and/or other vehicles) in the surrounding environment. In some embodiments, the vehicle control system may also use the ultrasonic waves to determine speeds, positions (including distances), and/or other attributes of the objects relative to vehicle 100. The ultrasonic sensors may also be used, for example, for parking assistance. Ultrasonic waves may suffer from strong attenuation in air beyond a few meters. Therefore, ultrasonic sensors are primarily used for short-range object detection.

An IMU may measure the speed, linear acceleration or deceleration, angular acceleration or deceleration, or other parameters related to the motion of vehicle 100. A wheel sensor may include, for example, a steering angle sensor that measures the steering wheel position angle and rate of turn, a rotary speed sensor that measures wheel rotation speed, or another wheel speed sensor.

Radar sensors may emit radio frequency waves that can be used by the vehicle control system to detect objects (e.g., people, structures, and/or other vehicles) in the surrounding environment. In some embodiments, the vehicle control system may use the radio frequency waves to determine speeds, positions (including distances), and/or other attributes of the objects. The radar sensors may include long-range radars, medium-range radars, and/or short-range radars, and may be used, for example, for blind spot detection, rear collision warning, cross traffic alert, adaptive cruise control, and the like.

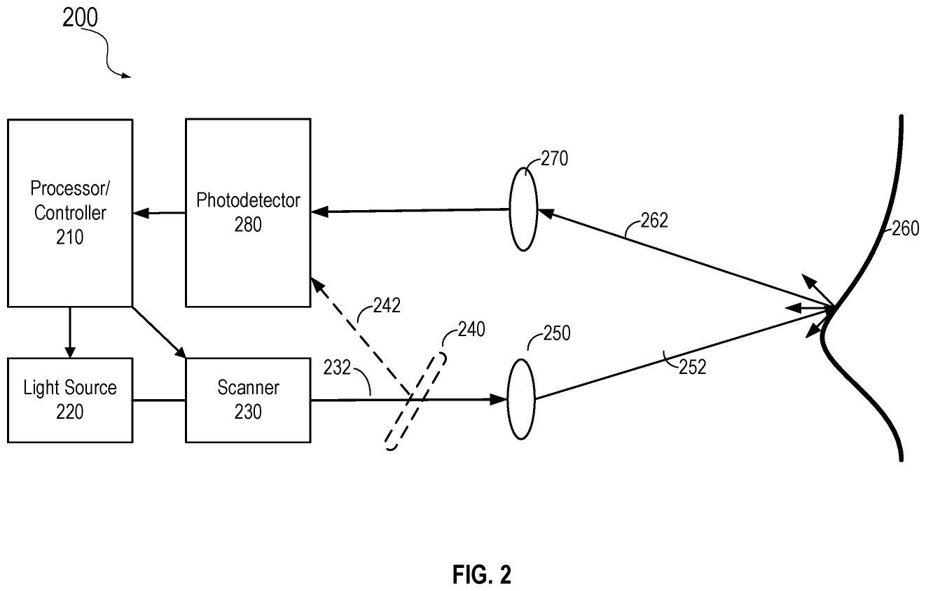

FIG. 2 is simplified block diagram of an example of a LiDAR system 200 according to certain embodiments. LiDAR system 200 may include a transmitter that may include a processor/controller 210, a light source 220, a scanner 230 for scanning an output light beam from light source 220, and a transmitter lens 250. Light source 220 may include, for example, a laser, a laser diode, a vertical cavity surface-emitting laser (VCSEL), a light-emitting diode (LED), or other optical sources. The laser may include, for example, an infrared pulsed fiber laser or other mode-locked laser with an output wavelength of, for example, 930-960 nm, 1030-1070 nm, around 1550 nm, or longer. Processor/controller 210 may control light source 220 to transmit light pulses. Scanner 230 may include, for example, a rotating platform driven by a motor, a multi-dimensional mechanical stage, a Galvo-controlled mirror, a microelectromechanical (MEMS) mirror driven by micro-motors, a piezoelectric translator/transducer using piezoelectric material such as a quartz or lead zirconate titanate (PZT) ceramic, an electromagnetic actuator, a resonant fiber scanner, or an acoustic actuator. In one example, LiDAR system 200 may include a single-point scanning system that uses a micro-electro-mechanical system (MEMS) combined with a mirror to reflect a pulsed light beam to a single point in the field of view. In some embodiments, scanner 230 may not include a mechanically moving component, and may use, for example, a phased array technique where phases of an array of light beams (e.g., from lasers in a one-dimensional (1-D) or two-dimensional (2-D) laser array) may be modulated to alter the wavefront of the superimposed light beam. Transmitter lens 250 may direct a light beam 232 towards a target 260 as shown by light beam 252.

LiDAR system 200 may include a receiver that may include a receiver lens 270, a photodetector 280, and processor/controller 210. Reflected or scattered light beam 262 from target 260 may be collected by receiver lens 270 and directed to photodetector 280. Photodetector 280 may include a detector having a working (sensitive) wavelength comparable with the wavelength of light source 220. Photodetector 280 may be a high speed photodetector, such as a PIN photodiode with an intrinsic region between a p-type semiconductor region and an n-type semiconductor region, a silicon photomultiplier (SiPM) sensor, an avalanche photodetector (APD), and the like. Processor/controller 210 may be used to synchronize and control the operations of light source 220, scanner 230, and photodetector 280, and analyze measurement results based on the control signals for light source 220 and scanner 230, and the signals detected by photodetector 280.

In some embodiments, a beam splitter 240 may split light beam 232 from scanner 230 and direct a portion of light beam 232 towards photodetector 280 as shown by light beam 242 in FIG. 2. Light beam 242 may be directed to photodetector 280 by beam splitter 240 directly or indirectly through one or more mirrors. In some embodiments, the light beam from the light source may be split and directed to the receiver before entering scanner 230. By partially directing the transmitted pulses near the transmission source to photodetector 280, the pulses captured by photodetector 280 immediately after transmission can be used as the transmitted pulses or reference pulses for determining the time of flight. To measure the time of flight, approximate positions of transmitted and returned pulses must be identified within the waveform of the detection signal of photodetector 280. A LiDAR system may use, for example, a leading-edge detector, a peak detector, or a matched-filter detector, to recover transmitted and/or returned light pulses in the detection signal from the photodetector.

In the example illustrated in FIG. 2, LiDAR system 200 may be a non-coaxial LiDAR system, where the receiver and the transmitter may use different optical components, and the outgoing light and the returned light may not spatially overlap. In some embodiments, the LiDAR systems may be coaxial systems, where, for example, the outgoing light and the returned light may be scanned by a same scanner and may at least spatially overlap at the scanner.

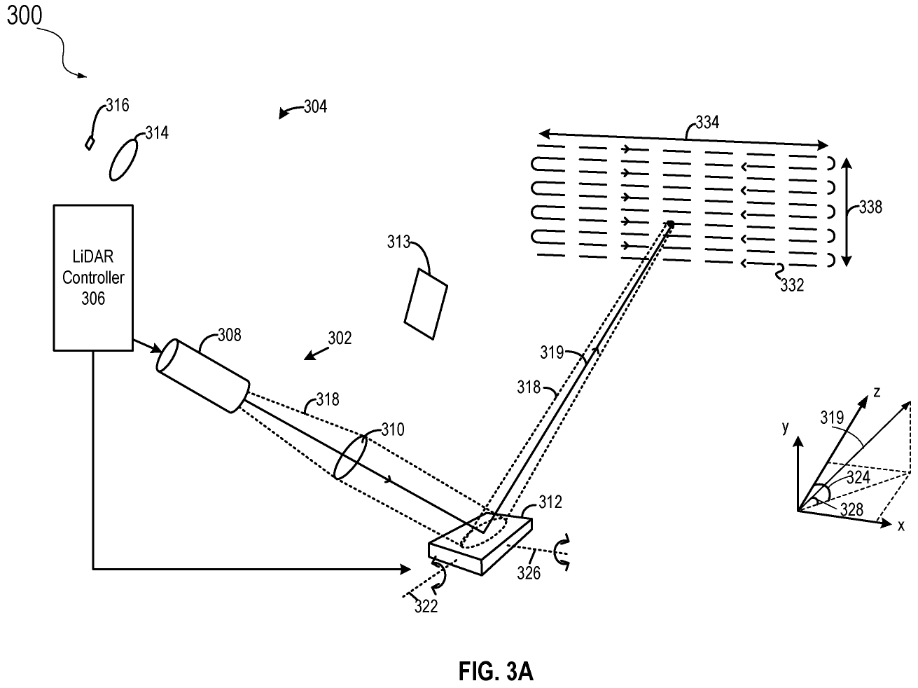

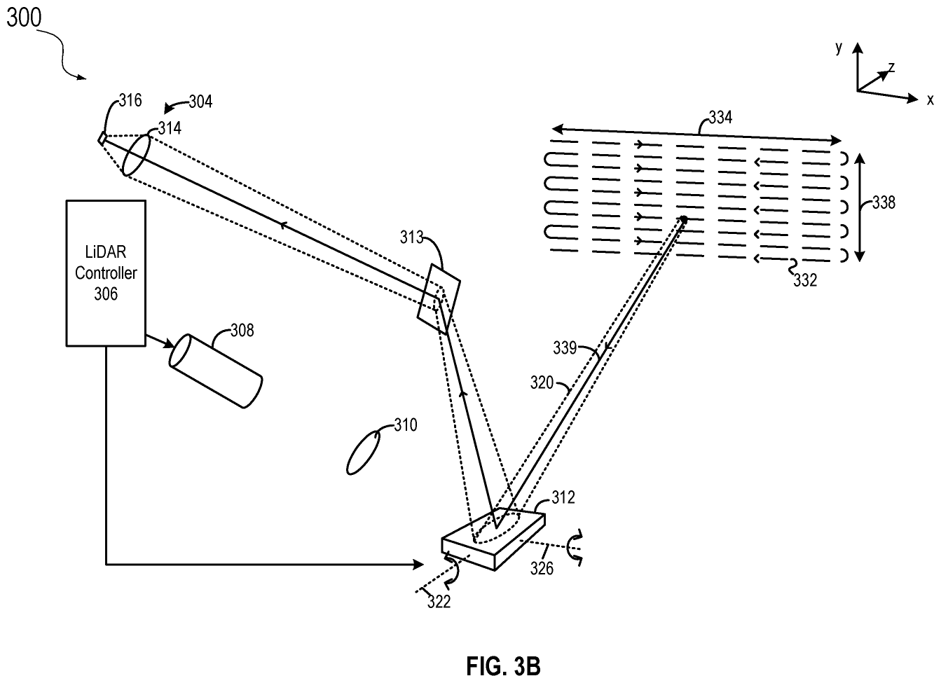

FIG. 3A and FIG. 3B illustrate simplified block diagram of an example of a LiDAR module 300 according to certain embodiments. LiDAR module 300 may be an example of LiDAR system 102, and may include a transmitter 302, a receiver 304, and a LiDAR controller 306 that controls the operations of transmitter 302 and receiver 304. Transmitter 302 may include a light source 308 and a collimator lens 310, whereas receiver 304 may include a lens 314 and a photodetector 316. LiDAR module 300 may further include a mirror assembly 312 and a beam deflector 313. In some embodiments, transmitter 302 and receiver 304 may be configured to share mirror assembly 312 (e.g., using a beam splitter/combiner) to perform light steering and detecting operation, with beam deflector 313 configured to reflect incident light reflected by mirror assembly 312 to receiver 304. In some embodiments, beam deflector 313 may also be shared by transmitter 302 and receiver 304 (e.g., via a beam splitter/combiner), where outgoing light from light source 308 and reflected by mirror assembly 312 may also be reflected by beam deflector 313, while the returned beam may be deflected by mirror assembly 312 and beam deflector 313 to lens 314 and photodetector 316.

FIG. 3A illustrates an example of a beam steering operation by LiDAR module 300. To project light, LiDAR controller 306 can control light source 308 to transmit a light beam 318 (e.g., light pulses, an FMCW light signal, an AMCW light signal, etc.). Light beam 318 may diverge upon leaving light source 308 and may be collimated by collimator lens 310. The collimated light beam 318 may propagate with substantially the same beam size.

The collimated light beam 318 may be incident upon mirror assembly 312, which can reflect and steer the light beam along an output projection path 319 towards a field of interest, such as object 112. Mirror assembly 312 may include one or more rotatable mirrors, such as a one-dimensional or two-dimensional array of micro-mirrors. Mirror assembly 312 may also include one or more actuators (not shown in FIG. 3A) to rotate the rotatable mirrors. The actuators may rotate the rotatable mirrors around a first axis 322, and/or may rotate the rotatable mirrors around a second axis 326. The rotation around first axis 322 may change a first angle 324 (e.g., longitude angle) of output projection path 319 with respect to a first dimension (e.g., the x-axis or z-axis), whereas the rotation around second axis 326 may change a second angle 328 (e.g., altitude angle) of output projection path 319 with respect to a second dimension (e.g., the y-axis). LiDAR controller 306 may control the actuators to produce different combinations of angles of rotation around first axis 322 and second axis 326 such that the movement of output projection path 319 can follow a scanning pattern 332. A range 334 of movement of output projection path 319 along the x-axis, as well as a range 338 of movement of output projection path 319 along the y-axis, can define a FOV. An object within the FOV, such as object 112, can receive and scatter the collimated light beam 318 to form returned light signals, which can be received by receiver 304.

FIG. 3B illustrates an example of a return beam detection operation by LiDAR module 300. LiDAR controller 306 can select an incident light direction 339 for detection of incident light by receiver 304. The selection can be based on setting the angles of rotation of the rotatable mirrors of mirror assembly 312, such that only light beam 320 propagating along incident light direction 339 is reflected to beam deflector 313, which can then divert light beam 320 to photodetector 316 via lens 314. Photodetector 316 may include any suitable high-speed detector that can detect light pulses in the working wavelength of the LiDAR system, such as a PIN photodiode, a silicon photomultiplier (SiPM) sensor, or an avalanche photodetector. With such arrangements, receiver 304 can selectively receive signals that are relevant for the ranging/imaging of a target object, such as light pulse 110 generated by the reflection of the collimated light beam by object 112, and not to receive other signals. As a result, the effect of environment disturbance on the ranging/imaging of the object can be reduced, and the system performance can be improved.

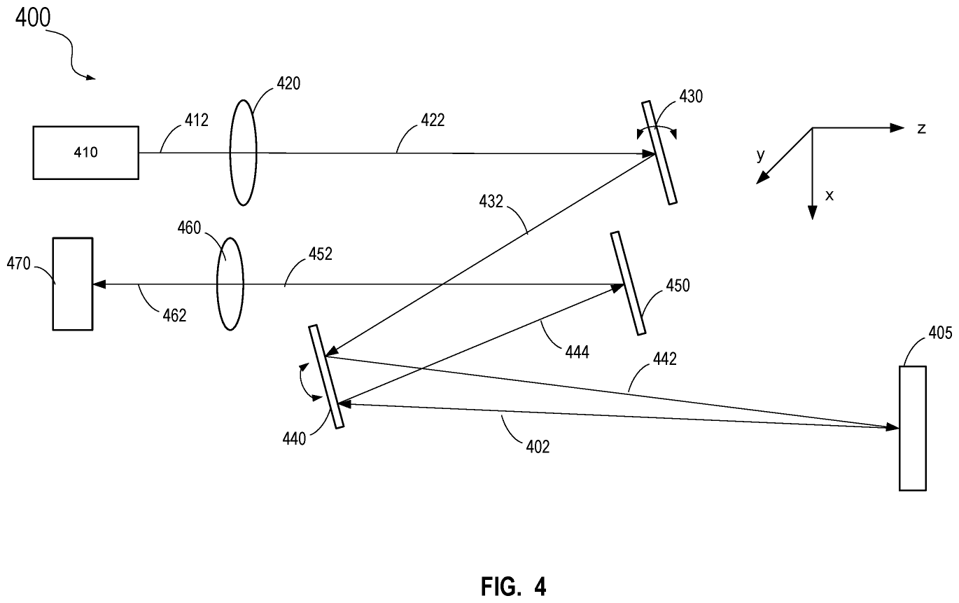

FIG. 4 is a simplified block diagram of an example of an optical subsystem 400 in a LiDAR system, such as LiDAR system 102 shown in FIG. 1, according to certain embodiments. In some embodiments, a plurality of optical subsystems 400 can be integrated into the LiDAR system to achieve, for example, 360° coverage in the transverse plane. In one example, a LiDAR system may include eight optical subsystems 400 distributed around a circle, where each optical subsystem 400 may have a field of view about 450 in the transverse plane.

In the example shown in FIG. 4, optical subsystem 400 may include a light source 410, such as a laser (e.g., a pulsed laser diode). A light beam 412 emitted by light source 410 may be collimated by a collimation lens 420. The collimated light beam 422 may be incident on a first deflector 430, which may be stationary or may rotate in at least one dimension such that collimated light beam 422 may at least be deflected by first deflector 430 towards, for example, different y locations. Collimated light beam 432 deflected by first deflector 430 may be further deflected by a second deflector 440, which may be stationary or may rotate in at least one dimension. For example, second deflector 440 may rotate and deflect collimated light beam 432 towards different x locations. Collimated light beam 442 deflected by second deflector 440 may reach a target point at a desired (x, y) location on a target object 405. As such, first deflector 430 and second deflector 440 may, alone or in combination, scan the collimated light beam in two dimensions to different (x, y) locations in a far field.

Target object 405 may reflect collimated light beam 442 by specular reflection or scattering. At least a portion of the reflected light 402 may reach second deflector 440 and may be deflected by second deflector 440 as a light beam 444 towards a third deflector 450. Third deflector 450 may deflect light beam 444 as a light beam 452 towards a receiver, which may include a lens 460 and a photodetector 470. Lens 460 may focus light beam 452 as a light beam 462 onto a location on photodetector 470, which may include a single photodetector or an array of photodetectors. Photodetector 470 may be any suitable high-speed detector that can detect light pulses in the working wavelength of the LiDAR system, such as a PIN photodiode, an SiPM sensor, or an avalanche photodetector. In some embodiments, one or more other deflectors may be used in the optical path to change the propagation direction of the light beam (e.g., fold the light beam) such that the size of optical subsystem 400 may be reduced or minimized without impacting the performance of the LiDAR system. For example, in some embodiments, a fourth deflector may be placed between third deflector 450 and lens 460, such that lens 460 and photodetector 470 may be placed in desired locations in optical subsystem 400.

The light deflectors described above may be implemented using, for example, a micro-mirror array, a Galvo mirror, a stationary mirror, a grating, or the like. In one example, first deflector 430 may include a micro-mirror array, second deflector 440 may include a Galvo mirror, and third deflector 450 and other deflectors may include stationary mirrors. A micro-mirror array can have an array of micro-mirror assemblies, with each micro-mirror assembly having a movable micro-mirror and an actuator (or multiple actuators). The micro-mirrors and actuators can be formed as a microelectromechanical system (MEMS) on a semiconductor substrate, which may allow the integration of the MEMS with other circuitries (e.g., controller, interface circuits, etc.) on the semiconductor substrate.

As described above, it may be desirable that a LiDAR system can detect objects in a wide range of distances, such as from about 1 meter to greater than about 200 meters. However, the strength or signal levels of the returned light pulses may be affected by the distance of the object, and many other factors. Generally, in a LiDAR system, the light intensities of the measured signals for middle and long ranges may decrease with the increase in the detection range. Light signals returned from long ranges (e.g., about 200 m) may be very weak and may have signal strength levels close to the ambient noise level, or may not even be detected by some photodetectors.

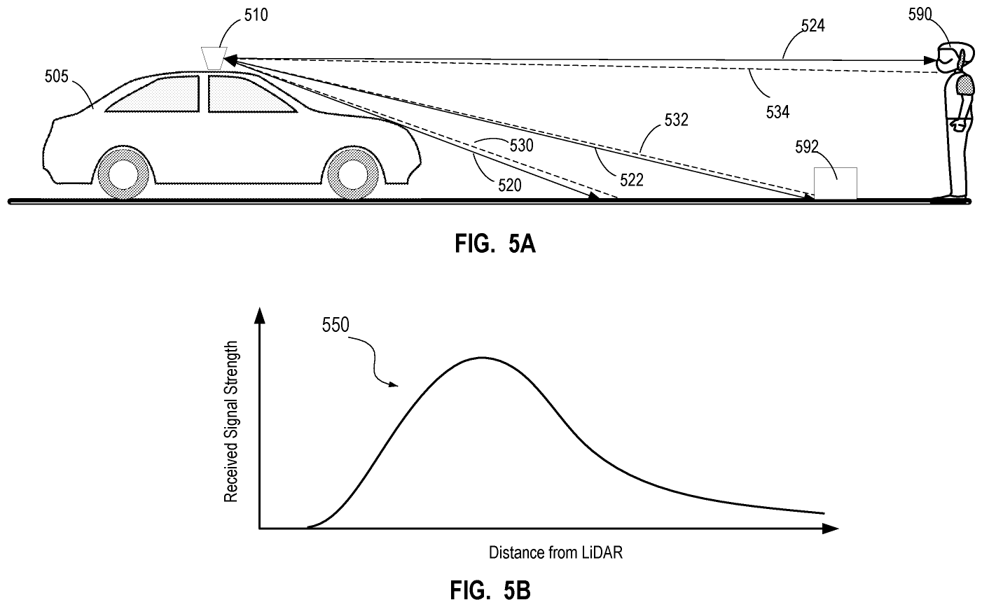

FIG. 5A illustrates an example of a LiDAR system 510 for detecting objects in different distance ranges. LiDAR system 510 may be installed on a vehicle 505, and may be used to detect objects, such as a subject 590 in a longer distance or an object 592 at a shorter distance in front of or surrounding vehicle 505. In the example shown in FIG. 5A, a transmitter of LiDAR system 510 may have a vertical field of view between a line 520 and a line 524. The receiver of LiDAR system 510 may have a vertical field of view between a line 530 and a line 534. The incident angles of the transmitted light on the objects and the angles of the reflected or scattered light that may reach the receiver may be different for objects at different ranges. In the illustrated example, the incident angle of the transmitted light (shown by line 524) on subject 590 at a far distance may be close to zero, and the reflection angle of the returned light from subject 590 (shown by line 534) that may reach the receiver may be around zero. The incident angle of the transmitted light (shown by a line 522) on object 592 at a middle range may be greater than zero, and the reflection angle of the returned light from object 592 (shown by a line 532) that may reach the receiver may be greater than zero. The incident angle of the transmitted light (shown by line 520) on objects at a short range may be much larger than zero, and the reflection angle of the returned light from the short range (shown by a line 530) that may reach the receiver may be much greater than zero.

FIG. 5B includes a curve 550 that illustrates an example of a relation between the received signal strength and the object distance for an example of a LiDAR system. As described above, the signal level of the returned light pulses may be affected by the distance of the object, and other factors, such as the transmitted light signal strength, the attenuation in the propagation medium, the interaction between the transmitted light and the objects, the properties of the objects, the performance of the receiver in the LiDAR system, and the like. In a simplified model, the number Nₛ of received photons by the photodetector of the LiDAR system may be:

$${N}_{s} = {N}_{L} \times {T}_{1} \times β ( θ , R ) \times {T}_{2} \times \frac{A}{{R}^{2}} \times η \times G + {N}_{B} .$$

In the above equation, NL is the number of transmitted photons, T₁ is the transmissivity of the medium in the light path from the light source to the object, β(θ, R) is the probability that a transmitted photon is scattered by the object into a unit solid angle and may be a function of the cosine of the incident angle θ and the range R, T₂ is the transmissivity of the medium in the light path from the object to the receiver,

$$\frac{A}{{R}^{2}}$$

is the probability that a scattered photon is collected by the receiver (the solid angle subtended by the receiver aperture with an area A from the scattering object), η is the optical efficiency of the LiDAR hardware (e.g., mirrors, lenses, filters, detectors, etc.), and G is the geometrical form factor that describes the overlap between the area of light irradiation with the field of view of the receiver optics and is a function of range R. N_{B} is the background noise and other noises, such as solar radiation, streetlights, headlights, and electronic device noises. Therefore, as shown in FIG. 5B, the received signal strength may be the highest for middle range detection, and may be lower for short ranges and long ranges.

To increase the received signal strength, the transmitted power may be increased. However, due to safety concerns, the maximum output power of the light source (e.g., a laser) is regulated to keep the laser energy/output power below eye safety limits defined by the regulations. The regulations may impact the selection of the laser wavelength, the operating mode of the LiDAR system (e.g., pulsed or continuous), and the detection methods and the photodetectors. For example, in a flash LiDAR system where a 2D scene is illuminated at a same time, the received optical power may be proportional to 1/R⁴, where R is the distance. In beam-steering LiDAR systems, the received optical power may be proportional to 1/R². Thus, beam-steering LiDAR systems may be better suited for long range detection.

LiDAR system usually employ lasers sources with wavelengths in the infrared band, such as from about 0.80 to about 1.55 μm, to take advantage of the atmospheric transmission window (and in particular of water) at these wavelengths, while using light beams not visible to human eyes. Lasers operating in shorter wavelengths in near-infrared (NIR) regions may have lower output power/energy limits as human eyes may focus shorter-wavelength NIR light onto retina thus concentrating the laser radiation onto a small region. Longer-wavelength NIR laser light may be absorbed in the cornea and thus may have higher output power/energy limits. For example, for a 1-ns laser pulse, the laser safety limit for 1550 nm may be 1,000,000 times higher than that for a laser operating at 905 nm. Some examples of lasers for use in LiDAR systems include solid-state lasers (SSL) and diode lasers (DLs).

Photodetectors are the photon sensing devices in LiDAR receivers for ToF measurement. A photodetector needs to have a high sensitivity to light in a certain wavelength range because only a small fraction of the light emitted by the laser may reach the photodetector. Si-based detectors may be used to detect light with wavelengths between about 0.3 μm and about 1.1 μm. InGaAs detectors may be used to detect light with wavelengths above 1.1 μm, although they may have acceptable sensitivities for light with wavelengths longer than 0.7 μm. The photodetectors may also need to have a high bandwidth for detecting short pulses, a minimal time jitter, a high dynamic range, and a high signal-to-noise ratio (S/N or SNR). The SNR may need to be greater than 1 for the detection to have useful information, and the higher the SNR, the more accurate the distance measurement may be. The noise in a LiDAR system may include, for example, unfiltered background, and dark current and gain variation of the photodetector and the amplifier. The measured distance uncertainty may be approximated by:

$${σ}_{d}^{2} \text{∼} \frac{{c}^{2}}{4 {B}^{2} \frac{S}{N}} ,$$

where B is the detection bandwidth (set by the pulse duration), c is the speed of light in free space, and S/N is the signal-to-noise ratio. Thus, it is desirable that the photodetector has a high spectral photosensitivity, a high gain with a low noise, a low dark current, and a small terminal capacitance (for a higher bandwidth). There may be several types of detectors that can be used in LiDAR systems, such as PIN diodes, APDs, SPADs, multi-pixel photon counters (MPPC), and photomultiplier tubes (PMT). However, it may be difficult to make a photodetector that has all the desired performance described above.

According to certain embodiments, a LiDAR system may include a receiver that includes an APD for near range detection and SPADs (e.g., an SiPM) for long range detection. The APD is capable of detecting light intensity in a linear mode, and therefore can generate detection signals with high dynamic ranges and high signal-to-noise ratios for accurate and reliable short to middle range detection. The high dynamic range of the detection signal can be utilized by increasing the number of bits and the resolution of the analog-to-digital converter following the detector and a low noise amplifier. The SiPM can have a very high gain value, and therefore can be used to detect weaker signal returned from long distances to improve the longer range detection capability of the LiDAR system. Because the intensity of the long range signal is low, LiDAR systems with low dynamic ranges can be used for long range detection if there are no high intensity interference signals from shorter ranges, and thus the LiDAR system can use the SiPM for long range detection.

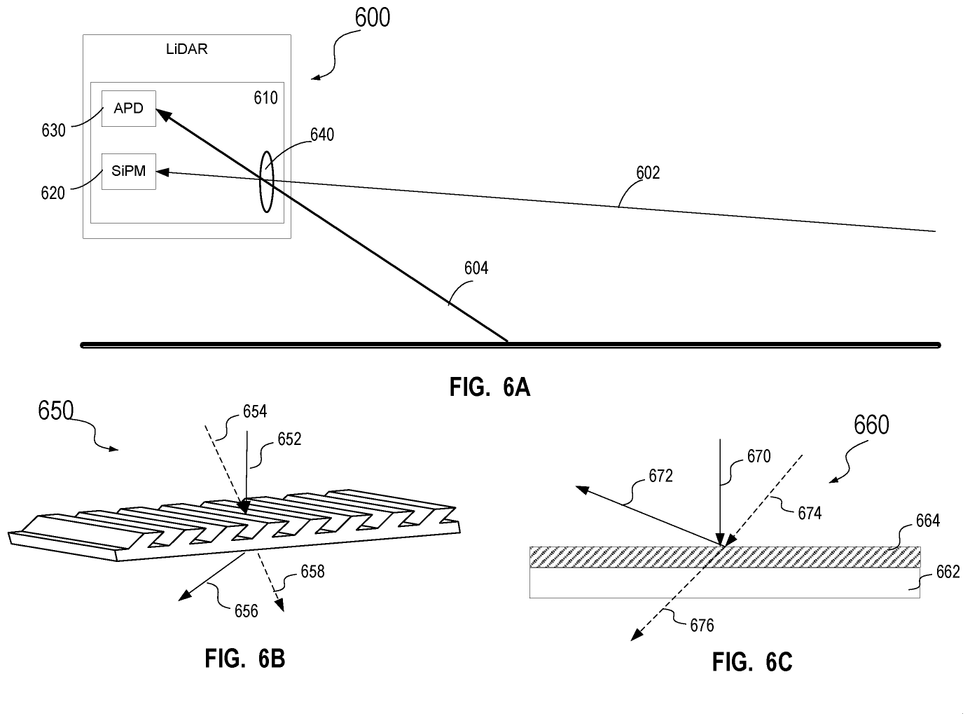

FIG. 6A illustrates an example of a LiDAR system 600 having multiple photodetectors for different detection ranges according to certain embodiments. In the illustrated example, only a portion of a receiver 610 of LiDAR system 600 is shown. Receiver 610 may include receiver optics 640, an APD 630, an SiPM 620, and other components (e.g., electric circuits) not shown in FIG. 6. Returned light from different distance ranges may have different incidence angle on receiver 610. Thus, receiver optics 640 may be configured to direct the returned light from different ranges to different photodetectors. For example, returned light from a long range as illustrated by a line 602, which may have a lower intensity, may be directed to SiPM 620 that may have a high sensitivity and a large gain. Returned light from a middle or short range as illustrated by, for example, a line 604, may have a higher intensity, and may be directed to APD 630 that may have a relatively large gain and a high dynamic range. In this way, receiver 610 may include hybrid detecting devices and thus may achieve both a wide detection range and a high detection accuracy due to improved dynamic range and signal-to-noise ratio.

Receiver optics 640 may include, for example, a lens or a lens assembly that may focus incident light from different field of views onto different areas on an image plane. In some embodiments, receiver optics 640 may include gratings, such as volume Bragg gratings, surface-relief gratings, or blazed gratings that have angular selectivity, such that light with different incident angles may be diffracted to different directions towards different photodetectors.

FIG. 6B illustrates an example of a surface-relief grating 650 that may be used in receiver optics 640 to separate returned light from different ranges according to certain embodiments. Surface-relief grating 650 may include a transmission grating or a reflection grating. In the illustrated example, surface-relief grating 650 may include a transmission grating that may have high diffraction efficiencies for incident light from a certain angular range and very low diffraction efficiencies for incident light from other angular ranges. Thus, surface-relief grating 650 may diffract, with high diffraction efficiencies, incident light from a certain angular range, and may transmit incident light from other angular ranges. For example, surface-relief grating 650 may diffract incident light 652 to a direction 656 (e.g., in the first diffraction order), and may transmit incident light 654 to a direction 658. APD 630 and SiPM 620 may be positioned at different locations such that each of them may receive the diffracted or transmitted light. In some embodiments, incident light from a certain field-of-view range (e.g., the region between the middle range and the long range) may be both diffracted (e.g., with a diffraction efficiency less than 100%) and transmitted by surface-relief grating 650, such that both APD 630 and SiPM 620 may receive at least of a portion of the returned light from this field-of-view range to have some overlap between their respective fields of review for better range coverage and more reliable detection.

FIG. 6C illustrates an example of a volume Bragg grating 660 that may be used in receiver optics 640 to separate returned light from different ranges according to certain embodiments. Volume Bragg grating 660 may include a transmission grating or a reflection grating. In the illustrated example, volume Bragg grating 660 may include a grating layer 664 formed on a substrate 662, where a reflection volume Bragg grating may be recorded in grating layer 664. The reflection volume Bragg grating may have very high diffraction efficiencies for incident light from a certain angular range and very low diffraction efficiencies for incident light from other angular ranges. For example, the reflection volume Bragg grating may be a saturated reflection grating with a high refractive index modulation, such that the diffraction curve as a function of the incident angle may have a wide main lobe with a flat top (saturated diffraction efficiency, such as about 100%). Thus, volume Bragg grating 660 may diffract, with high efficiencies, incident light from a certain angular range, and may transmit incident light from other angular ranges. For example, volume Bragg grating 660 may reflectively diffract incident light 670 to a direction 672 (e.g., in the first diffraction order), and may transmit incident light 674 to a direction 676. APD 630 and SiPM 620 may be positioned at different locations such that each of them may receive the diffracted or transmitted light. In some embodiments, incident light from a certain field-of-view range (e.g., the region between the middle range and the long range) may be both diffracted (e.g., with a diffraction efficiency less than 100%) and transmitted by volume Bragg grating 660, such that both APD 630 and SiPM 620 may receive at least of a portion of the returned light from this field-of-view range to have some overlap between their respective fields of review for better range coverage and more reliable detection.

In some embodiments, APD 630 and SiPM 620 may each include an array of detector elements. In some embodiments, other combinations of APDs, SPADs, and other types of photodetectors (e.g., PINs) may be used for detection in different ranges. For example, in some embodiments, receiver 610 may include three different types of photodetectors. The suitable photodetectors may be selected based on the specific application, the architecture of the LiDAR system, and the characteristics of the different types of photodetectors, such as the gain and noise performance of the photodetectors.

The gain may enable a photodetector to increase the available signal from an input by increasing the power or amplitude of a signal from the input (e.g., the initial number of photoelectrons generated by the incoming photons that are absorbed) to the output (the final number of photoelectrons sent to the digitizer). The gain of the photodetector indicates the number of electrons that are produced by a single photon that is successfully absorbed to generate an electron-hole pair. The gain may be determined as the mean ratio of the output power to the input signal, where a gain greater than 1 indicates a signal amplification.

The noise of a photodetector may include the unwanted, irregular fluctuations introduced by the photodetector and the associated electronics. The noise of the photodetector may be represented by a standard deviation (σₙₒᵢₛₑ):

σₙₒᵢₛₑ=\sqrt{σₛₕₒₜ²+σₜₕ²+σ_{bg}²+σᵣₒ²+σₛₚ².}

Thermal noise σₜₕ may be caused by the thermal motion of the electrons inside the semiconductor material. Shot noise σₛₕₒₜ may be related to the statistical fluctuations in the optical signal itself and the statistical interaction process with the photodetector, and may be relevant in low light intensity applications where the statistics of photon arrival become observable. Background noise σ_{bg} may be caused by background illumination in the same wavelength of the laser pulses. Readout noise σᵣₒ may be due to the fluctuations in the generation and/or amplification of the photoelectrons. Speckle noise σₛₚ may be caused by the presence of speckle fluctuations in the received laser signal. Background, readout, and speckle noise may be amplified by the gain mechanism of the photodetector, while thermal noise σₜₕ and shot noise σₛₕₒₜ may be fixed. When the thermal noise and/or the shot noise are the dominant noise source, the photodetector may be in the thermal or shot noise regimes, and a large gain G may significantly improves the SNR of the photodetector that may be determined by:

$$SNR = \frac{G \times {N}_{s i g n a l}}{\sqrt{{σ}_{s h o t}^{2} + {σ}_{t h}^{2} + {G}^{2} \times {σ}_{b g}^{2} + {G}^{2} \times {σ}_{r o}^{2} + {G}^{2} \times {σ}_{s p}^{2}}} ,$$

where N_{signal} is the number of photoelectrons generated by the received photons.

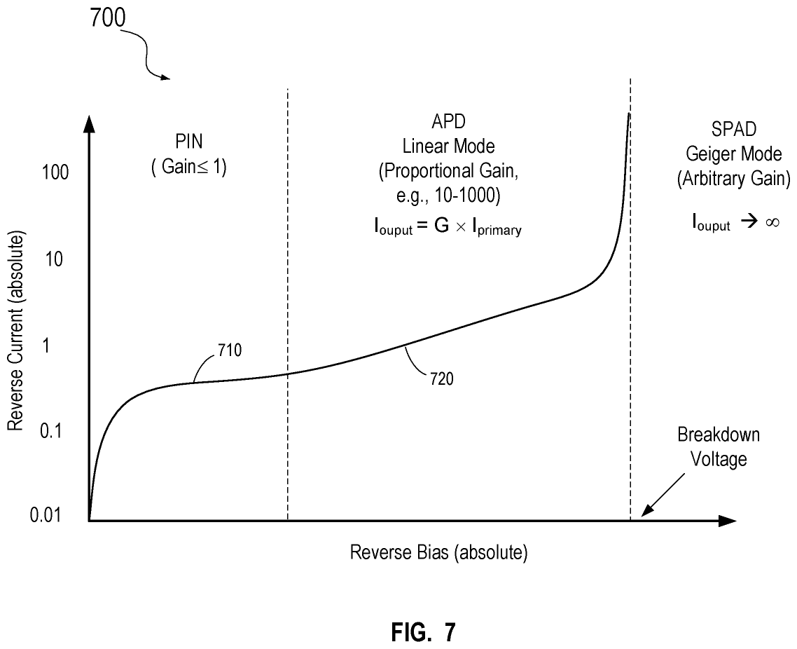

FIG. 7 includes a diagram 700 illustrating the operation conditions and current-voltage (I-V) curves for different types of photodetectors, such as PIN diodes, APDs, and SPADs. As illustrated, PIN diodes, APDs, and SPADs may all operate in reverse biased conditions. PIN diodes may be reverse biased at a bias voltage much lower than the breakdown voltage. PIN diodes may have an IV curve as shown by a curve 710, where the reverse current is low and the gain may be no greater than one (and thus no amplification). PIN diodes may have very high bandwidths and time resolutions, thus may be used to detect fast events, such as short pulses or pulses that may be close to each other, if the PIN diodes have sufficient sensitivity for the application.

For applications that need moderate to high sensitivity and can tolerate lower bandwidths (e.g., below the GHz regimes of PIN diodes), APDs may be used. APDs may provide a certain level of amplification of the current generated by the incident light, such as with a gain between about 10 to about 1000. The gain of an APD may be proportional to the reverse bias applied, as shown by an I-V curve 720, when the reverse bias voltage is below the breakdown voltage. Therefore, APDs are linear devices with adjustable gains and can generate an output current proportional to the received optical power.

Single-photon avalanche diodes are reversely biased beyond the breakdown voltage (in Geiger mode), and may be configured to withstand repetitive avalanche events. In a SPAD, a single photon may produce a large number of electrons, which results in a large photocurrent and a large gain. An array of SPADs may be combined to form a multi-pixel photon counter, such as an SiPM, where the outputs of all SPADs in the array may be combined to generate a single analog output, thus effectively enabling photon counting under low light intensity conditions.

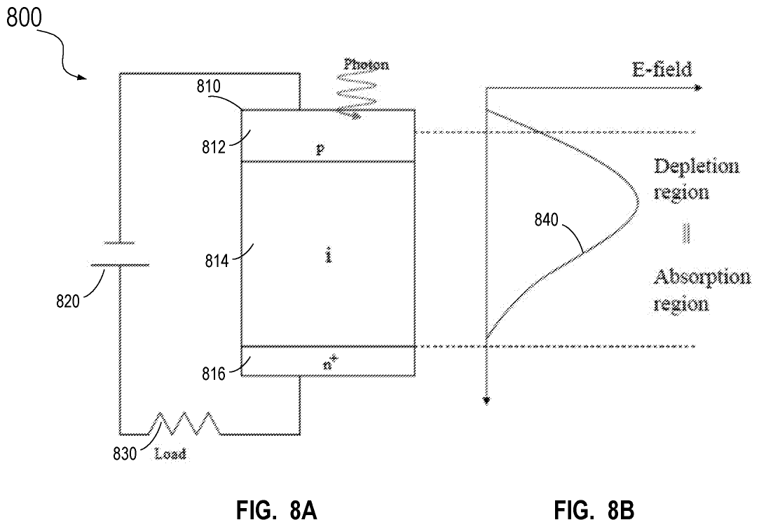

FIG. 8A illustrates an example of a detection circuit 800 including a PIN photodetector 810. FIG. 8B illustrates an example of an operation condition of PIN photodetector 810 shown in FIG. 8A. PIN photodetector 810 may include a p-type region 812, an intrinsic region 814, and an n-type region 816. PIN photodetector 810 may be reverse-biased by a power supply 820 through a load 830 (e.g., a resistor or a signal amplifier). Intrinsic region 814 may be a wide, undoped intrinsic semiconductor region between p-type region 812 and n-type region 816. Under the reverse bias condition, a large depletion region including intrinsic region 814 may be formed. The electric field in PIN photodetector 810 generated by the reverse bias may be shown by a curve 840, where the electric field may be high in the depletion region. When a photon with enough energy enters the depletion region, the photon may be absorbed by the semiconductor material to create an electron-hole pair. The field generated by the reverse bias may then sweep the carriers out of the depletion region to create a photocurrent proportional to the number of incoming photons. The photocurrent may then be sent to an amplification circuit (e.g., load 830) and a digitizer for measurement. In PIN photodetectors, most of the photons are absorbed in the intrinsic region, and carriers generated therein can efficiently contribute to the photocurrent. As described above, PIN photodiodes may not amplify the initial current generated by absorbed photons, but may have high bandwidths (e.g., up to about 100 GHz, depending on its size and capacitance) for measuring light with higher intensities. PIN photodetectors may be manufactured using various materials, such as Si, InGaAs, CdTe, and the like.

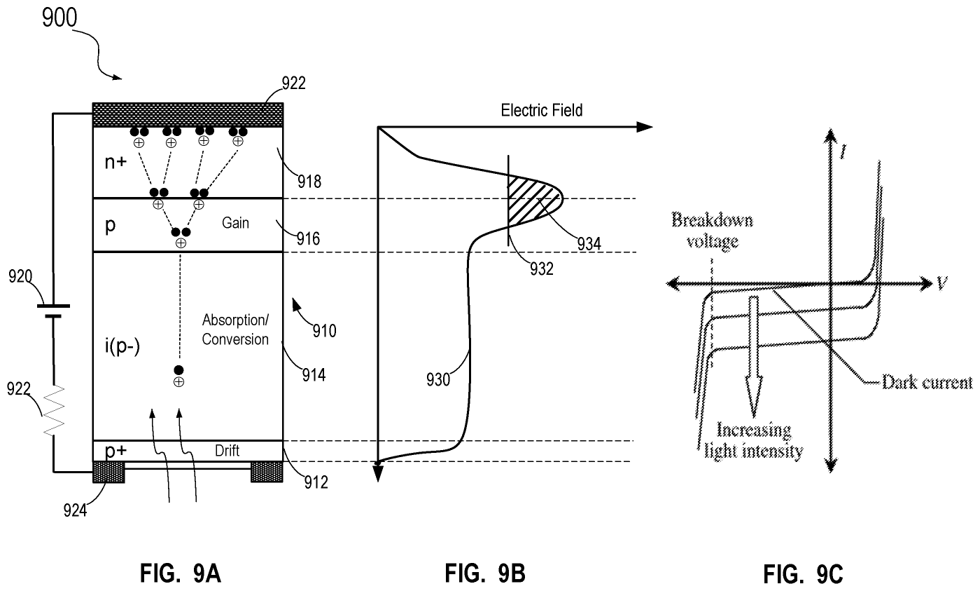

FIG. 9A illustrates an example of a detection circuit 900 including an APD 910 for light detection. Detection circuit 900 also includes a power supply 920 that may apply a reverse bias on APD 910 through a load 922 (e.g., a resistor or an amplifier). APD 910 may be a diode-based photodetector operated under a relatively high reverse bias voltage (e.g., tens or even hundredths of volts), sometimes just below the breakdown voltage of the diode. In the illustrate example, APD 910 may include a p⁺-type region 912, an intrinsic (or p⁻-type) region 914, a p-type region 916, and an n⁺-type region 918. The p⁺-type region 912 may be a carrier drift region. The incident photons may be absorbed in intrinsic region 914 to generate a limited number of electron-hole pairs. A strong internal electric field generated by the high reverse bias voltage may accelerate the photon-generated carriers in intrinsic region 914. The accelerated carriers may impact the semiconductor material in p-type region 916 (the gain region) to create additional secondary electrons due to impact ionization, resulting in an electron avalanche process that may take place over a distance of a few micrometers. The electron avalanche process can produce a gain value up to a few hundreds. The gain of the APD indicates the number of photoelectrons that are created with each successful detection of a photon, and thus the effective responsivity of the detector. The gain may vary from device to device and may strongly depend on the reverse bias voltage applied.

FIG. 9B illustrates an example of an operation condition of APD 910 shown in FIG. 9A. Under the reverse bias, the electric field inside an example of APD 910 may be shown by a curve 930. The electric field in p⁺-type region 912 and n⁺-type region 918 may be relatively low. The electric field in intrinsic (or p⁺-type) region 914 may be higher and flat. The electric field at the interface between p-type region 916 and n⁺-type region 918 may be the highest due to the depletion region formed at the interface under the reverse bias. A line 932 in FIG. 9B shows the minimum field needed for impact ionization. A shaded area 934 represents the avalanche region.

FIG. 9C illustrates examples of I-V curves of an APD illuminated by light of different intensities. As illustrated, the photocurrent of an APD under reverse bias voltages below the breakdown voltage may linearly increase with the light intensity and the reverse bias voltage. The gain of an APD under the same incident light intensity may increase linearly when the reverse bias voltage increases. When the bias voltage is fixed, the photocurrent may increase as the incident light intensity increases. When the APD is operated near its maximum gain (and thus close to the breakdown voltage), the APD response may not be linear anymore.

APDs are very sensitive photodetectors. However, the avalanche process may cause fluctuations in the generated current and thus higher noise. The noise associated with the statistical fluctuations in the gain process may be referred to as the excess noise, and may be affected by several factors, such as the magnitude of the reverse voltage, the properties of the material (in particular, the ionization coefficient ratio), and the device design. Increasing the gain may also increase the excess noise. Therefore, the optimal gain values to achieve the maximum SNR performance for different operating conditions may be different, usually well below the maximum achievable gain.

Compared with PIN photodiodes, APDs may have comparable or slightly lower bandwidths, but may be able to measure lower light levels, and thus may be used in applications where a high sensitivity is desired. APDs can be in in either 1D or 2D arrays, and can be made to have large dimensions, such as with photosensitive areas about 10×10 mm² or larger, especially in Si. However, APDs may not be sensitive enough for single-photon detection under very low light intensity conditions.

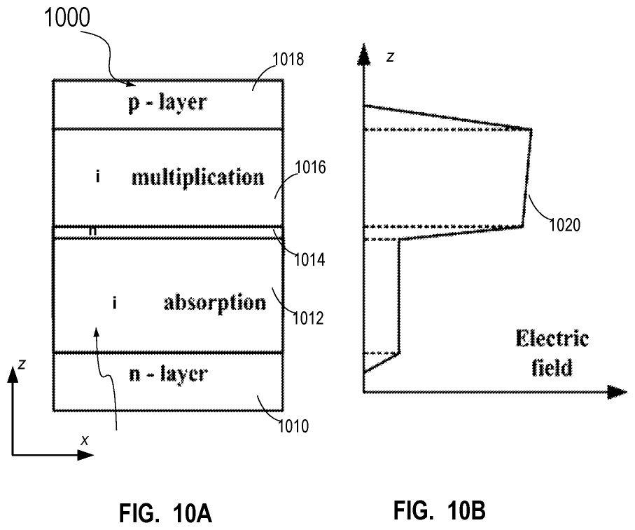

FIG. 10A illustrates an example of a SPAD 1000 for light detection. SPADs may be similar to APDs, but may operate in the Geiger mode where the reverse bias voltage is above the breakdown threshold voltage. In the illustrated example, SPAD 1000 may include an n-type layer 1010, an intrinsic layer 1012, an n-type layer 1014, an intrinsic region 1016, and a p-type layer 1018. The n-type layer 1010 may include, for example, an n-type InP or silicon buffer layer. Intrinsic layer 1012 may be an absorption layer where an incoming photon may be absorbed to generate an electron-hole pair. Intrinsic layer 1012 may include, for example, an undoped InGaAs or silicon layer. The n-type layer 1014 may include, for example, an n-type InGaAs grading layer and an n-type InP charging layer, or a n-type silicon layer. Intrinsic region 1016 may be a multiplication region where most of the gain is achieved. In one example, intrinsic region 1016 may include an undoped InP or silicon layer. The p-type layer 1018 may include, for example, a p⁺-type InP or silicon layer.

FIG. 10B illustrates an example of an operation condition of SPAD 1000 shown in FIG. 10A. Under the reverse bias, the electric field in SPAD 1000 may be shown by a curve 1020. The electric field may be high in the intrinsic regions, in particular, the multiplication region where the avalanche process may occur. The avalanche process may be similar to the avalanche process described with respect to the APDs. In SPADs, the electric field is much higher such that a single electron-hole pair injected into the multiplication layer may trigger a strong, self-sustained avalanche. The current may rise quickly to a macroscopic steady level and may keep flowing until the avalanche process is quenched. As such, the photocurrent is not linearly amplified, but may reach a certain current value (e.g., a saturation current level) regardless of whether the photocurrent is triggered by only one incident photon or by several incident photons. Thus, a SPAD may function as an optically activated switch that may be in an “ON” state when one or more photons are absorbed or in an “OFF” state when no photon is absorbed. The structure of SPADs may be different from those of linear mode APDs in order to withstand repeated avalanche processes and to have efficient and fast quenching mechanisms for switching on and off repeatedly, without compromising the response of the photodetector.

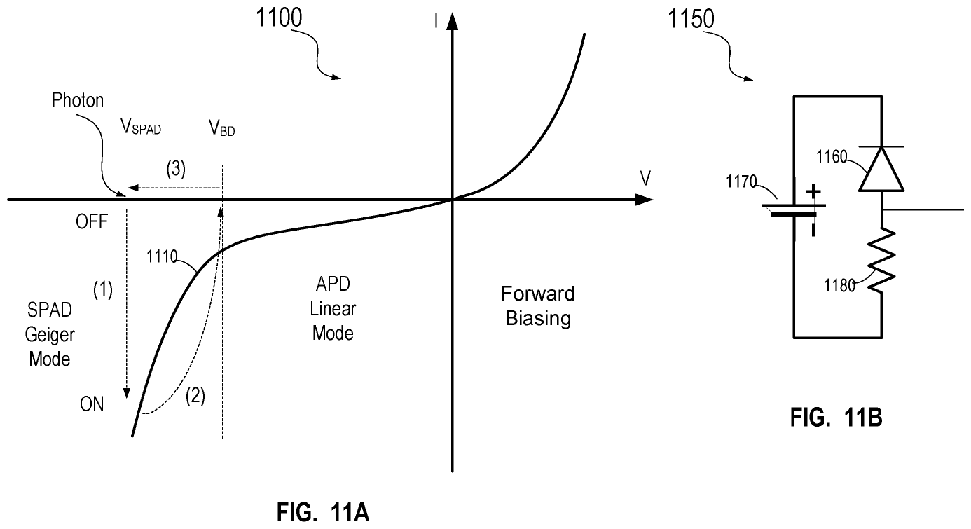

FIG. 11A includes a chart 1100 showing an example of an I-V curve 1110 and operating states of a SPAD. As described above, the SPAD may operate in the Geiger mode with a reverse bias voltage greater than the breakdown voltage V_{BD}. The SPAD may be in the “OFF” state when no photon is received. When a photon is absorbed, the photocurrent generated by the avalanche process may reach a high level in step (1), and the SPAD may enter the “ON” state. For effective Geiger-mode operation, the avalanche process may need to be stopped to bring the photodetector back to its original quiescent state (the “OFF” state) for next photon detection. The quenching may be performed by a quenching circuit. After the large photocurrent is triggered, the quenching circuit may reduce the bias voltage at the photodiode to a level below the breakdown voltage V_{BD} in step (2) to stop the avalanche process. After the quenching, the photocurrent may be reduced to zero, and thus the voltage drop on the quenching circuit may be reduced to zero. Thus, after a recovery and recharge process in step (3), the SPAD may again be biased above the breakdown voltage V_{BD}, restore its sensitivity, and be ready for the reception of more photons. The dead-time (e.g., about 100 ns) during step (2) and step (3) when the SPAD may not respond to incoming photons, may reduce the count rate and leave the device unresponsive, and thus may significantly affect the bandwidth of the SPAD. In some embodiments, the bandwidth of the SPAD may be improved by improving the quenching circuit.

FIG. 11B is a simplified circuit 1150 for light detection using a SPAD 1160 according to certain embodiments. Circuit 1150 may include SPAD 1160, a power supply 1170, and a quenching circuit 1180. Power supply 1170 may apply the reverse bias voltage on SPAD 1160 through quenching circuit 1180. Quenching circuit 1180 may be a passive circuit or an active circuit. For example, in a passive quenching process, the avalanche process may be stopped by decreasing the bias voltage of SPAD 1160 below the breakdown voltage using a resistor having a high resistance and thus a large voltage drop when the current is high. In an active quenching process, the avalanche process may be interrupted by an active current feedback loop, where the rise of the avalanche process may be sensed through a low impedance circuit to trigger a reaction on the SPAD. The reaction may include controlling the bias voltage using active components (e.g., pulse generators or fast active switches) to force the quenching and resetting the SPAD in shorter time periods. Thus, the active quenching circuit may help to overcome the slow recovery of the passive quenching technique to improve the bandwidth of the SPAD.

In SPADs, the macroscopic current generated due to the avalanche process may be detected when the current is above a threshold, and thus the photon detection is binary or digital. There may be some mechanisms that can trigger the avalanche process when no photon is received and generate noise. One noise source in SPADs is the thermally-generated carriers, where the generation-recombination processes within the semiconductor material as a result of thermal fluctuations may induce the avalanche and produce a false detection. Another noise in SPADs is the after-pulsing, where, during the avalanche, some carriers may be captured by deep energy levels in the junction depletion layer, and may be released subsequently after a statistically fluctuating delay. The delayed released carriers may retrigger the avalanche process to generate after-pulses. The after-pulses may increase with the delay of the avalanche quenching and the current intensity.

Due to the single photon detection capability, SPADs can be efficient for low light detection, and can be used when an extremely high sensitivity is needed. The intensity of the light signal may be obtained by repeated illumination cycles and counting the number of output pulses received within a measurement time window. In some embodiments, statistical measurements of the time-dependent waveform of the light signal may be obtained by measuring the time distribution of the received pulses using time-correlated single-photon counting (TCSPC) techniques.

Multi-pixel photon counters (MPPCs), such as silicon photomultipliers (SiPMs), may include arrays of SPADs (referred to as cells) with individual SPADs of various sizes. For example, a MPPC may have between about 100 and several thousand cells per square millimeter, depending on the size of each cell. The output signals of the individual cells may be combined into a joint analog signal that may be proportional to the number of cells triggered by photons, thus enabling photon counting beyond the digital on/off photon detection capability of individual cells. When a cell is triggered in response to an absorbed photon, the Geiger avalanche causes a photocurrent to flow through the cell, where the output of the cell may have a fixed amplitude that does not vary with the number of photons entering the cell at the same time. The avalanche process is confined to the single cell that absorbed the photon, while other cells that have not absorbed photons remain fully charged and ready to detect photons. The output amplitude may be the same for each cell that absorbed one or more photons. Thus, when multiple cells receive photons at the same time, the pulses generated by the multiple units may be superimposed onto each other to generate an aggregated pulse with a higher amplitude. Thus, MPPCs or SiPMs may have very high gains (e.g., about 106 or higher) and analog photon-counting capabilities. The linearity of the photon-counting capabilities may be reduced when more photons are incident on the device because the probability that more than one photon may reach a same cell may increase.

In general, increasing the reverse voltage may increase the electric field inside the device, and thus improve the gain, photon detection efficiency, and time resolution. Increasing the reverse voltage may also increase certain undesired effects that may lower the SNR, such as false triggers due to thermal noise and after pulsing. Thus, the operating voltage must need to be optimized in order to achieve the desired characteristics.

Another type of photodetectors for LiDAR applications is the photomultiplier tubes (PMTs). PMTs are based on the external photoelectric effect, where a photoelectron may be extracted from a material when a photon is incident on a photosensitive area of the material within a vacuum tube. The photoelectron may be accelerated to impact a cascaded series of electrodes (referred to as dynodes) to generate more electrons by impact ionization at each impact, thus creating a cascaded secondary emission. PMTs can have gains up to about 10⁸. The rise times of PMTs may be in the nanosecond scale, and thus the bandwidths of PMTs can be high (e.g., >1 GHz). However, PMTs are bulky, fragile devices that may be affected by magnetic fields. PMTs may also use high-voltage power supplies.

Based on the particular application, a LiDAR receiver disclosed herein may include any combinations of one or more PIN diodes, one or more APDs, one or more SPADs, one or more MPPCs (e.g., one or more SiPMs), and one or more PMTs, in order to achieve the desired performance for short, middle, and long range detection. The photodetectors may be selected based on the characteristics of the different types of photodetectors summarized in Table 1.

TABLE 1
Summary of main features of photodetectors for LiDAR Application

| | PIN | APDs | SPADs | MPPCs (SiPMs) | PMTs |
|---|---|---|---|---|---|
| Solid state | Yes | Yes | Yes | Yes | No |
| Gain (typical) | ≤1 | Linear (<10³) | Geiger (~10⁴) | Geiger (~10⁶) | Avalanche (~10⁶) |
| Main | Fast | Linear operation, | Single photon | individual | High gain, UV |
| advantages | | adjustable gain | detection | photons | detection |
| | | by bias | | counting | |
| Main | low gain, | Limited gain, | Recovery time | Saturable, | Bulky, low quantum |
| disadvantages | low SNR | limited | | bias voltage | efficiency, high |
| | | sensitivity | | dependence | voltage, susceptible |
| | | | | | to magnetic fields |

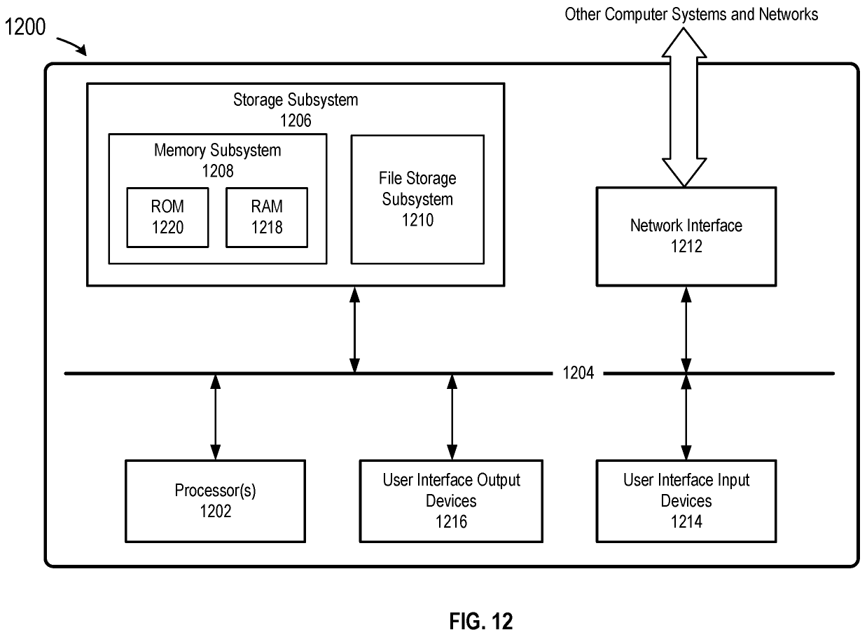

FIG. 12 illustrates an example of a computer system 1200 for implementing some of the embodiments disclosed herein. Computer system 1200 can be used to implement any of the LiDAR systems discussed above. For example, computer system 1200 may be used to implement LiDAR system 102, processor/controller 210, LiDAR controller 306, or other systems, subsystems, units, or components described herein. Computer system 1200 can include one or more processors 1202 that can communicate with a number of peripheral devices (e.g., input devices) via an internal bus subsystem 1204. These peripheral devices can include storage subsystem 1206 (comprising memory subsystem 1208 and file storage subsystem 1210), user interface input devices 1214, user interface output devices 1216, and a network interface subsystem 1212.

In some examples, internal bus subsystem 1204 can provide a mechanism for letting the various components and subsystems of computer system 1200 communicate with each other as intended. Although internal bus subsystem 1204 is shown schematically as a single bus, alternative embodiments of the bus subsystem can utilize multiple buses. Additionally, network interface subsystem 1212 can serve as an interface for communicating data between computer system 1200 and other computer systems or networks. Embodiments of network interface subsystem 1212 can include wired interfaces (e.g., Ethernet, CAN, RS-232, RS-485, etc.) or wireless interfaces (e.g., ZigBee, Wi-Fi, cellular, etc.).

In some cases, user interface input devices 1214 can include a keyboard, pointing devices (e.g., mouse, trackball, touchpad, etc.), a barcode scanner, a touch-screen incorporated into a display, audio input devices (e.g., voice recognition systems, microphones, etc.), Human Machine Interfaces (HMI) and other types of input devices. In general, use of the term “input device” is intended to include all possible types of devices and mechanisms for inputting information into computer system 1200. Additionally, user interface output devices 1216 can include a display subsystem, a printer, or non-visual displays such as audio output devices, etc. The display subsystem can be any known type of display devices. In general, use of the term “output device” is intended to include all possible types of devices and mechanisms for outputting information from computer system 1200.

Storage subsystem 1206 can include memory subsystem 1208 and file storage subsystem 1210. Subsystems 1208 and 1210 represent non-transitory computer-readable storage media that can store program code and/or data that provide the functionality of disclosed herein. In some embodiments, memory subsystem 1208 can include a number of memories including main random access memory (RAM) 1218 for storage of instructions and data during program execution and read-only memory (ROM) 1220 in which fixed instructions may be stored. File storage subsystem 1210 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 1200 is illustrative and not intended to limit embodiments of the present disclosure. Many other configurations having more or fewer components than computer system 1200 are possible. The various embodiments further can be implemented in a wide variety of operating environments, which in some cases can include one or more user computers, computing devices or processing devices, which can be used to operate any of a number of applications. User or client devices can include any of a number of general purpose personal computers, such as desktop or laptop computers running a standard or non-standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially available protocols, such as TCP/IP, UDP, OSI, FTP, UPnP, NFS, CIFS, and the like. The network can be, for example, a local area network, a wide-area network, a virtual private network, the Internet, an intranet, an extranet, a public switched telephone network, an infrared network, a wireless network, and any combination thereof.

In embodiments utilizing a network server as the operation server or the security server, the network server can run any of a variety of server or mid-tier applications, including HTTP servers, FTP servers, CGI servers, data servers, Java servers, and business application servers. The server(s) also may be capable of executing programs or scripts in response to requests from user devices, such as by executing one or more applications that may be implemented as one or more scripts or programs written in any programming language, including but not limited to Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or browser. It should be appreciated that alternate embodiments may have numerous variations from that described above. F or example, customized hardware might also be used and/or particular elements might be implemented in hardware, software (including portable software, such as applets) or both. Further, connections to other computing devices such as network input/output devices may be employed.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some embodiments. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A light detection and ranging (LiDAR) system comprising a receiver, the receiver comprising:
a first photodetector configured to detect individual photons;
a second photodetector characterized by a linear response to an intensity level of incident light; and
a receiver optic device configured to:
collect returned light from a first field of view and a second field of view of the receiver;
direct the returned light from the first field of view of the receiver to the first photodetector; and
direct the returned light from the second field of view of the receiver to the second photodetector.

2. The LiDAR system of claim 1, wherein the first photodetector includes at least one of a single-photon avalanche photodiode, a silicon photomultiplier, a multi-pixel photon counter, or a photomultiplier tube.

3. The LiDAR system of claim 1, wherein the first photodetector is characterized by a gain greater than 1000.

4. The LiDAR system of claim 1, wherein the first photodetector is configured to count a total number of received photons.

5. The LiDAR system of claim 1, wherein the first photodetector includes a photodiode that is reverse-biased at a bias voltage greater than a breakdown voltage of the photodiode such that an avalanche process is triggered when the first photodetector absorbs a photon.

6. The LiDAR system of claim 5, wherein the receiver further comprises a quenching circuit configured to reduce the bias voltage of the first photodetector after the avalanche process is triggered.

7. The LiDAR system of claim 6, wherein the quenching circuit includes a passive quenching circuit or an active quenching circuit.

8. The LiDAR system of claim 1, wherein the first field of view includes a field that is at least 200 meters from the receiver.

9. The LiDAR system of claim 1, wherein the second photodetector is characterized by a gain greater than 10.

10. The LiDAR system of claim 9, wherein the gain of the second photodetector is a linear function of a reverse bias voltage applied to the second photodetector.

11. The LiDAR system of claim 1, wherein the second photodetector includes an avalanche photodiode.

12. The LiDAR system of claim 1, wherein the receiver optic device includes a lens, a lens assembly, a surface-relief grating, or a volume Bragg grating.

13. The LiDAR system of claim 1, wherein the returned light is characterized by a wavelength between 0.80 and 1.55 μm.

14. The LiDAR system of claim 1, wherein:
the receiver further comprises a third photodetector; and
the receiver optic device is further configured to direct returned light from a third field of view of the receiver to the third photodetector.

15. The LiDAR system of claim 1, further comprising:
a light source configured to emit infrared light; and
a scanner configured to direct the infrared light emitted by the light source to both the first field of view and the second field of view of the receiver.

16. A light detection and ranging (LiDAR) receiver comprising:
a first photodetector characterized by a first gain greater than 1000;
a second photodetector characterized by a second gain less than 1000 and a linear response to an intensity level of incident light; and
a receiver optic device configured to:
collect returned light from a first field of view and a second field of view of the LiDAR receiver;
direct the returned light from the first field of view of the LiDAR receiver to the first photodetector; and
direct the returned light from the second field of view of the LiDAR receiver to the second photodetector.

17. The LiDAR receiver of claim 16, wherein the first photodetector includes at least one of a single-photon avalanche photodiode, a silicon photomultiplier, a multi-pixel photon counter, or a photomultiplier tube.

18. The LiDAR receiver of claim 16, wherein the second photodetector includes an avalanche photodiode.

19. The LiDAR receiver of claim 16, wherein the first field of view includes a field that is at least 200 meters from the LiDAR receiver.

20. The LiDAR receiver of claim 16, wherein the receiver optic device includes at least one of a lens, a lens assembly, a surface-relief grating, or a volume Bragg grating.
